(19) United States
(12) Patent Application Publication
(10) Pub. No.: US 2026/0278224 A1
(43) Pub. Date: Sep. 17, 2026

(54) IN-SITU PREDICTION OF PART QUALITY IN ADDITIVE MANUFACTURING USING SENSOR AND SIMULATION FUSION

(71) Applicants: VIRGINIA TECH INTELLECTUAL PROPERTIES, INC., Blacksburg, VA (US); NUtech Ventures, Lincoln, NE (US)

(72) Inventors: Benjamin Bevans, Blacksburg, VA (US); Alexander Riensche, Radford, VA (US); Kevin D. Cole, Lincoln, NE (US); Prahalada Rao, Radford, VA (US)

(21) Appl. No.: 19/569,984

(22) Filed: Mar. 17, 2026

Related U.S. Application Data
(60) Provisional application No. 63/773,199, filed on Mar. 17, 2025.

(51) Int. Cl. G06F 30/27; G06F 113/10; G06F 119/08

(52) U.S. Cl. CPC G06F 30/27; G06F 2113/10; G06F 2119/08

(57) ABSTRACT

In-situ sensor data acquired from a plurality of sensors during fabrication of a part by an additive manufacturing process is processed to extract sensor-derived features on a layer-by-layer basis. A physics-based thermal model predicts thermal history quantifiers for the part. The sensor-derived features and the thermal history quantifiers are spatially aligned on a layer-by-layer basis and combined as inputs to a hierarchical machine learning model trained on ground-truth characterization data. A first echelon of the hierarchical machine learning model classifies a presence or absence of a fabrication defect. For portions of the part classified as absence of the fabrication defect, a second echelon predicts a microstructure characteristic, such as a meltpool depth, a grain size, or a microhardness. The combination of sensor-derived features and simulation-derived thermal history quantifiers provides a digital twin of the fabrication process enabling in-situ quality assessment.

### CROSS-REFERENCE TO RELATED PATENT APPLICATION

This application claims the benefit of and priority to U.S. Provisional Application No. 63/773,199, filed Mar. 17, 2025, titled “MODEL PREDICTIVE CONTROL FOR IMPROVED PART QUALITY IN LASER POWDER BED FUSION,” the entire contents of which is hereby incorporated herein by reference.

### BACKGROUND

Additive manufacturing processes, such as laser powder bed fusion (LPBF), fabricate parts in a layer-by-layer manner by selectively melting thin layers of metallic powder with energy from a scanning laser. LPBF is favored for its ability to manufacture intricate, high-performance components from a range of metallic materials, including nickel-based superalloys, stainless steels, and titanium alloys. These capabilities have generated significant interest in safety-critical sectors, such as aerospace and defense, where the geometric complexity and material performance achievable through LPBF can reduce part count, decrease weight, and enhance supply chain responsiveness.

Qualification of LPBF parts for safety-critical applications typically relies on post-process inspection and characterization. Non-destructive techniques, such as X-ray computed tomography (CT), are often employed to assess internal porosity and geometric integrity. However, the fidelity of X-ray CT is contingent on the material and geometry of the sample, and dense alloys can progressively attenuate the X-ray beam, limiting the maximum penetrable thickness and the minimum detectable flaw size. Furthermore, the resolution of X-ray CT is generally insufficient to characterize microstructural aspects, such as grain size and meltpool morphology. To quantify microstructural characteristics, representative coupons are often manufactured alongside the actual component and characterized using destructive metallographic techniques, such as optical and scanning electron microscopy. This witness coupon approach for indirect qualification of the microstructure can be prone to uncertainty, because different LPBF part shapes, even when produced under identical processing parameters, may not result in similar microstructure due to variations in their thermal history.

Data-driven approaches, in which in-situ sensor data, such as infrared thermal imaging and optical imaging, is correlated to part quality using machine learning models, have been explored as alternatives to post-process inspection. These sensor-based approaches can be effective at detecting certain types of flaws, such as porosity, in simple coupon geometries. However, purely data-driven models are often trained on data obtained from simple shapes and may perform poorly when applied to practical, complex geometries, because they do not account for the causal effect of part shape and material properties on the thermal phenomena that drive flaw formation and microstructure evolution. In addition, sensors positioned above or outside the part during fabrication generally observe only surface-level thermal phenomena and cannot directly measure sub-surface temperature gradients and cooling rates that influence microstructure development. Physics-based models, such as thermal simulations, can predict sub-surface thermal phenomena but are often computationally demanding, particularly for full-scale parts, and do not account for stochastic process variations that occur during fabrication.

### SUMMARY

The following is a summary provided to introduce a selection of concepts in a simplified form that are further described below in the detailed description. This summary is not intended to identify key features or essential features of the claimed subject matter, nor is it intended to be used to limit the scope of the claimed subject matter.

A system is provided that includes at least one computing device and instructions stored in the at least one computing device. The instructions, when executed by at least one processor of the at least one computing device, cause the at least one computing device to acquire in-situ sensor data from a plurality of sensors during fabrication of a part by an additive manufacturing process, extract sensor-derived features from the in-situ sensor data on a layer-by-layer basis, predict thermal history quantifiers for the part using a physics-based thermal model, input the sensor-derived features and the thermal history quantifiers to a machine learning model trained on ground-truth characterization data, and output a predicted part quality characteristic for the part based on an output of the machine learning model.

In various implementations, the instructions may further cause the at least one computing device to classify, using a first echelon of the machine learning model, a presence or absence of porosity for each layer of the part, and for layers classified as absence of porosity, predict, using a second echelon of the machine learning model, at least one of a meltpool depth, a grain size, or a microhardness.

In various implementations, the plurality of sensors may include a long-wave infrared thermal camera and an optical tomography sensor.

In various implementations, the sensor-derived features may include an end-of-cycle temperature extracted from the long-wave infrared thermal camera, a meltpool intensity extracted from the optical tomography sensor, and an inter-layer time derived from time-synchronized data acquired by the long-wave infrared thermal camera and the optical tomography sensor.

In various implementations, the thermal history quantifiers may include a predicted end-of-cycle temperature and a predicted cooling time.

In various implementations, the physics-based thermal model may include a graph theory-based thermal model that discretizes a geometry of the part into a plurality of nodes connected by edges to form a network graph, constructs a Laplacian matrix from the network graph, and computes eigenvalues and eigenvectors of the Laplacian matrix.

In various implementations, the sensor-derived features may further include at least one of a spatial standard deviation of an end-of-cycle temperature, a spatial standard deviation of a meltpool intensity, or a spatial standard deviation of a predicted end-of-cycle temperature.

In various implementations, the predicted part quality characteristic may include at least one of: a classification of lack-of-fusion porosity, a meltpool depth, a primary dendritic arm spacing, or a microhardness.

A computer-implemented method is also provided. The method includes acquiring, by at least one computing device, in-situ sensor data from a plurality of sensors during fabrication of a part by an additive manufacturing process, extracting sensor-derived features from the in-situ sensor data on a layer-by-layer basis, predicting thermal history quantifiers for the part using a physics-based thermal model, spatially aligning the sensor-derived features and the thermal history quantifiers on a layer-by-layer basis, inputting the spatially aligned sensor-derived features and the thermal history quantifiers to a machine learning model, and predicting at least one part quality characteristic based on an output of the machine learning model.

In various implementations, predicting the at least one part quality characteristic may include classifying, using a first echelon of the machine learning model, a presence or absence of lack-of-fusion porosity for each layer of the part, and for layers classified as absence of lack-of-fusion porosity, predicting, using a second echelon of the machine learning model, at least one of a meltpool depth, a grain size, or a microhardness.

In various implementations, spatially aligning may include agglomerating thermal history quantifiers from a super-layer resolution to an actual layer resolution.

In various implementations, the sensor-derived features may include an inter-layer time computed as a duration between a peak meltpool intensity timestamp acquired from an optical tomography sensor and an end-of-cycle temperature timestamp acquired from a long-wave infrared thermal camera.

In various implementations, the method may further include calibrating the physics-based thermal model by adjusting heat transfer boundary coefficients based on a comparison of a model-predicted end-of-cycle temperature to a measured end-of-cycle temperature extracted from the in-situ sensor data. The heat transfer boundary coefficients may include a heat loss coefficient from the part to a build plate, a heat loss coefficient from the part to surrounding powder, and a heat loss coefficient from the part to a gas flow.

In various implementations, a number of input features provided to the machine learning model may vary depending on the part quality characteristic being predicted.

In various implementations, the machine learning model may include a k-nearest neighbors model.

In various implementations, the additive manufacturing process may include a laser powder bed fusion process.

A non-transitory computer-readable medium is also provided. The non-transitory computer-readable medium stores instructions that, when executed by at least one processor, cause the at least one processor to receive in-situ sensor data acquired from a plurality of sensors during fabrication of a part by an additive manufacturing process, extract sensor-derived features from the in-situ sensor data, predict thermal history quantifiers for the part using a physics-based thermal model, combine the sensor-derived features and the thermal history quantifiers as inputs to a hierarchical machine learning model, the hierarchical machine learning model including a first echelon that classifies a presence or absence of a fabrication defect and a second echelon that predicts a microstructure characteristic for portions of the part classified as absence of the fabrication defect, and output the predicted microstructure characteristic.

In various implementations, the fabrication defect may include lack-of-fusion porosity, and the microstructure characteristic may include at least one of a meltpool depth, a primary dendritic arm spacing, or a microhardness.

In various implementations, the sensor-derived features and the thermal history quantifiers may be spatially aligned on a layer-by-layer basis prior to input to the hierarchical machine learning model.

In various implementations, the physics-based thermal model may predict the thermal history quantifiers using a mesh-free computational approach that represents a geometry of the part as a network graph of nodes connected by edges.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic block diagram of an additive manufacturing environment according to various implementations of the present disclosure.

FIG. 2 is a schematic block diagram of a digital twin data fusion architecture according to various implementations of the present disclosure.

FIG. 3 is a schematic block diagram of a hierarchical machine learning model for part quality prediction according to various implementations of the present disclosure.

FIG. 4 is a flow diagram of a method for in-situ prediction of part quality using a digital twin according to various implementations of the present disclosure.

### DETAILED DESCRIPTION

This patent application generally relates to additive manufacturing, and more specifically to in-situ prediction of part quality characteristics during laser powder bed fusion (LPBF) using a combination of in-situ sensor data and physics-based thermal simulation within a machine learning framework.

In LPBF, thin layers of metallic powder are deposited across a build plate and selectively melted by a laser to fabricate parts in a layer-by-layer manner. The spatiotemporal temperature distribution within a part during the build process, referred to as the thermal history, has a significant influence on the formation of flaws and the evolution of the solidified microstructure. Porosity, meltpool depth, grain size, and microhardness are among the part quality characteristics that are governed by the thermal history. The thermal history is influenced by a complex interplay of factors, including processing parameters such as laser power and scan velocity, part geometry, part orientation, and build layout. Parts of different shapes, even when produced under identical processing parameters, may exhibit different thermal histories and consequently different microstructure and flaw characteristics. Moreover, within a single part, the thermal history may vary from layer to layer as the cross-section, overhang features, and proximity to previously deposited material change during fabrication.

Current approaches for qualification of LPBF parts rely on post-process inspection. X-ray computed tomography can detect porosity and geometric deviations but is limited in resolution for dense alloys and cannot characterize microstructural aspects such as grain size. Metallographic examination of witness coupons provides microstructure information but is indirect because the thermal history of a standardized coupon may differ from that of the actual part. These post-process approaches are time-intensive and expensive, and the results are available only after fabrication is complete.

In one or more implementations, a computing device acquires in-situ sensor data from a plurality of sensors during fabrication of a part by an LPBF process. The plurality of sensors may include a long-wave infrared (LWIR) thermal camera and an optical tomography camera that capture complementary aspects of the process. The LWIR thermal camera captures part-level thermal phenomena that are responsive to changes in part geometry, while the optical tomography camera captures meltpool-level phenomena that are responsive to changes in processing parameters. Sensor-derived features, including an end-of-cycle temperature, a meltpool intensity, and an inter-layer time, are extracted from the sensor data on a layer-by-layer basis. In parallel, the computing device predicts thermal history quantifiers, including a predicted end-of-cycle temperature and a predicted cooling time, using a physics-based thermal model. The sensor-derived features and the thermal history quantifiers are combined as inputs to a hierarchical machine learning model. A first echelon of the hierarchical machine learning model classifies the presence or absence of a fabrication defect, such as lack-of-fusion porosity. For portions of the part classified as free of the fabrication defect, a second echelon of the hierarchical machine learning model predicts one or more microstructure characteristics, such as a meltpool depth, a grain size, or a microhardness. The combination of sensor-derived features capturing real-time process phenomena with simulation-derived quantifiers capturing sub-surface thermal information that is not directly observable by in-situ sensors provides a digital twin of the fabrication process that enables in-situ quality assessment on a layer-by-layer basis without post-process destructive testing.

In one or more implementations, the approaches described herein may provide one or more of the following advantages. Combining sensor-derived features and simulation-derived thermal history quantifiers as inputs to the machine learning model may improve prediction accuracy relative to using either data source alone, because the sensor data captures stochastic, real-time process variations while the simulation-derived quantifiers capture geometry-dependent, sub-surface thermal phenomena. The hierarchical machine learning architecture may enable early detection of porosity during fabrication, allowing an operator to identify process instability before microstructure prediction is performed. The layer-by-layer assessment may provide spatially resolved quality information throughout the part, in contrast to post-process techniques that sample only discrete locations or are limited by material penetration depth. The in-situ approach may reduce or eliminate the need for post-process X-ray computed tomography and destructive metallographic characterization for qualification of part quality. Additionally, because the physics-based thermal model accounts for the effect of part geometry on the thermal history, the approach may be transferable across different part shapes and processing conditions without retraining the machine learning model from scratch for each new geometry.

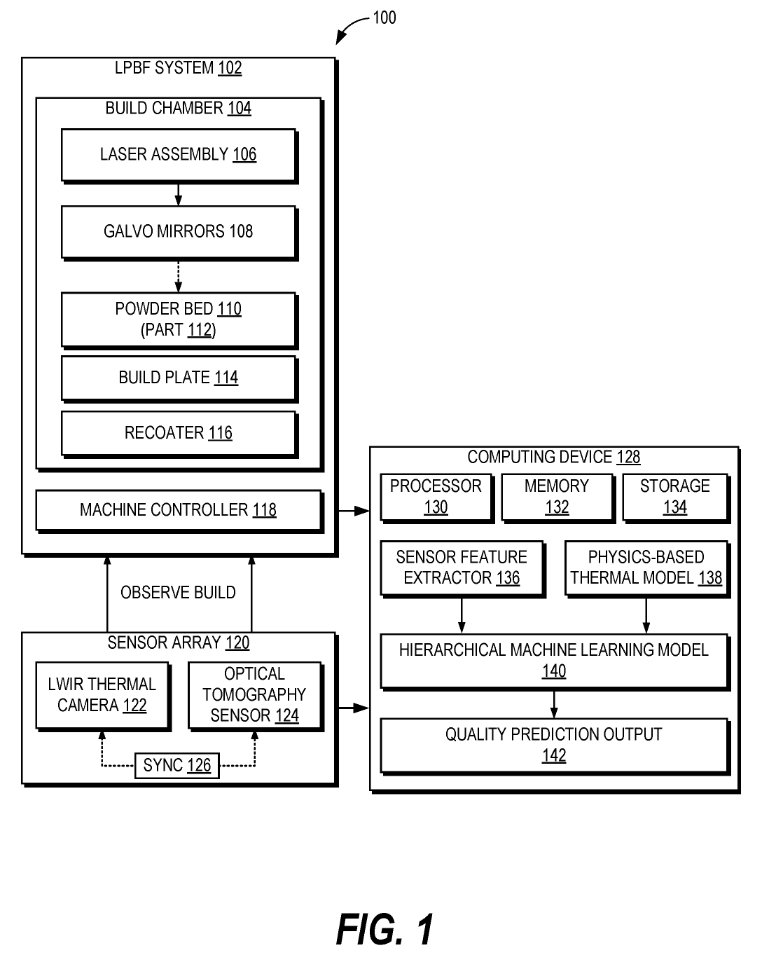

Turning to FIG. 1, shown is a schematic block diagram of an additive manufacturing environment 100 according to various implementations of the present disclosure. The additive manufacturing environment 100 facilitates in-situ prediction of part quality characteristics during a laser powder bed fusion (LPBF) process by combining sensor-derived features and simulation-derived thermal history quantifiers within a hierarchical machine learning framework. The additive manufacturing environment 100 includes an LPBF system 102, a sensor array 120, and a computing device 128.

The LPBF system 102 includes a build chamber 104 that encloses the components involved in the layer-by-layer fabrication of a part. The build chamber 104 may maintain an inert atmosphere, such as argon or nitrogen gas, during fabrication to mitigate oxidation and other adverse reactions.

The LPBF system 102 includes a laser assembly 106 that generates a laser beam for selectively melting metallic powder. In various implementations, the laser assembly 106 may include an infrared laser, such as a ytterbium fiber laser having a wavelength of approximately 1070 nanometers (nm), with a power output in the range of approximately 100 watts (W) to approximately 500 W. The laser beam from the laser assembly 106 is directed by galvanometric mirrors 108 onto a powder bed 110. The galvanometric mirrors 108 steer the laser beam across a surface of the powder bed 110 in accordance with a scan path derived from a digital representation of a part 112 being fabricated.

The powder bed 110 includes a layer of metallic powder material deposited on a build plate 114. In various implementations, the metallic powder material may include nickel-based superalloys (e.g., Inconel 718), stainless steel alloys (e.g., 316L), titanium alloys (e.g., Ti-6Al-4V), or other metallic materials suitable for LPBF processing. The metallic powder material may have a particle size distribution in the range of approximately 15 micrometers (µm) to approximately 45 µm. As the laser beam selectively melts the powder material, the part 112 is formed within the powder bed 110 in a layer-by-layer manner. Each layer may have a thickness in the range of approximately 20 µm to approximately 80 µm. For example, in one implementation, the layer thickness is approximately 30 µm.

A recoater 116 deposits successive layers of powder material across the build plate 114 between laser scanning operations. The recoater 116 may include a metal or polymer blade that traverses the powder bed 110 to spread a uniform layer of powder. A recoater cycle time, which is the duration for the recoater 116 to traverse the powder bed 110 and deposit a new layer, may be in the range of approximately 5 seconds to approximately 15 seconds.

The LPBF system 102 further includes a machine controller 118 that governs the operation of the laser assembly 106, the galvanometric mirrors 108, and the recoater 116 in accordance with machine-executable instructions. The machine controller 118 receives processing parameters, such as laser power, scan velocity, hatch spacing, and layer thickness, and directs the LPBF system 102 to fabricate the part 112 accordingly. In various implementations, the machine controller 118 may communicate processing parameter data to the computing device 128.

The sensor array 120 includes a plurality of in-situ sensors that observe the LPBF process during fabrication of the part 112. The sensor array 120 includes a long-wave infrared (LWIR) thermal camera 122 and an optical tomography sensor 124.

The LWIR thermal camera 122 captures thermal radiation emitted from the surface of the powder bed 110 and the part 112 during and between laser scanning operations. In various implementations, the LWIR thermal camera 122 may have a spectral range of approximately 8 µm to approximately 14 µm, a frame rate of approximately 30 hertz (Hz), and a spatial resolution of approximately 10 pixels per square millimeter (mm²). The LWIR thermal camera 122 may be positioned inside or adjacent to the build chamber 104 at an angle to the horizontal, such as approximately 60 degrees. The LWIR thermal camera 122 captures the surface temperature distribution of the powder bed 110 after the laser has melted a layer and a new layer of powder has been deposited but has not yet been melted. This temperature measurement, referred to herein as the end-of-cycle temperature (T e), is responsive to part-level thermal phenomena, such as heat retention and dissipation, which are influenced by the geometry of the part 112.

The optical tomography sensor 124 captures light emitted in the near-infrared regime during laser-powder interaction. In various implementations, the optical tomography sensor 124 may have a spectral range of approximately 750 nm to approximately 1000 nm, a spatial resolution of approximately 346 pixels per mm², and an exposure time of approximately 250 milliseconds (ms). The relatively long exposure time allows the optical tomography sensor 124 to detect the most intense light emitted at each pixel during a laser scanning operation. The optical tomography sensor 124 may be positioned above the build chamber 104, such as at an angle of approximately 83 degrees from the horizontal. A measurement extracted from the optical tomography sensor 124, referred to herein as the meltpool intensity (I m), represents the maximum near-infrared light intensity recorded at each pixel for each layer. The meltpool intensity (I m) is responsive to meltpool-level phenomena that are influenced by the processing parameters, such as the laser power and scan velocity.

The LWIR thermal camera 122 and the optical tomography sensor 124 are synchronized in time via a synchronization link 126. The synchronization link 126 enables temporal alignment of data from the two sensors, which facilitates extraction of a derived sensor feature referred to herein as the inter-layer time (t I). The inter-layer time (t I) is the duration between the peak of the laser strike at a location, as captured by the optical tomography sensor 124, and the end-of-cycle temperature at that location, as captured by the LWIR thermal camera 122. The inter-layer time (t I) is responsive to changes in the cross-sectional area of the build, because a larger cross-sectional area increases the time required for the laser to traverse all parts on the build plate 114 before the next layer of powder is deposited.

The computing device 128 includes at least one processor 130, a memory 132, and storage 134. The processor 130 may include one or more central processing units (CPUs), graphics processing units (GPUs), field-programmable gate arrays (FPGAs), or other processing circuits. The memory 132 may include volatile memory, such as random access memory (RAM), for storing data and instructions during execution. The storage 134 may include non-transitory computer-readable media, such as solid-state drives, hard disk drives, or other persistent storage, for storing instructions, trained machine learning models, sensor data, simulation results, and other data. The computing device 128 may be implemented as, for example, a desktop computer, a server, a workstation, a cloud computing instance, or any other computing platform suitable for the operations described herein. The instructions stored in the storage 134, when executed by the processor 130, cause the computing device 128 to perform the operations described herein, including sensor feature extraction, physics-based thermal modeling, and hierarchical machine learning prediction. Programs embodying the operations described herein may be stored on the storage 134 and executed by the processor 130. The programs may be written in, for example, C, C++, Python, Java, or other programming languages.

The computing device 128 includes a sensor feature extractor 136 that receives sensor data from the sensor array 120 and extracts sensor-derived features on a layer-by-layer basis for each part 112 being fabricated. The sensor-derived features may include the end-of-cycle temperature (T e) and its spatial standard deviation (σT e) extracted from the LWIR thermal camera 122, the meltpool intensity (I m) and its spatial standard deviation (σI m) extracted from the optical tomography sensor 124, and the inter-layer time (t I) derived from the synchronized timestamps of both sensors via the synchronization link 126. In various implementations, the sensor-derived features are aggregated as layer-wise mean and standard deviation values for each part 112 on the build plate 114. The LWIR thermal camera 122 and the optical tomography sensor 124 capture complementary aspects of the LPBF process. The LWIR thermal camera 122 is responsive to part-level changes in thermal history caused by changes in the geometry of the part 112, while the optical tomography sensor 124 captures variations in instantaneous, localized meltpool temperatures resulting from changes in processing parameters. The combination of sensor-derived features from both sensors spans multiple phenomenological scales of the LPBF process.

The computing device 128 further includes a physics-based thermal model 138 that predicts thermal history quantifiers for the part 112 based on a digital representation of the geometry of the part 112 and the processing parameters received from the machine controller 118. The thermal history quantifiers may include a predicted end-of-cycle temperature (T̂ e) and a predicted cooling time (t̂ c) for each layer of the part 112. The predicted end-of-cycle temperature represents the model-predicted steady-state layer temperature, and the predicted cooling time represents the duration for the temperature of a layer to cool from its peak to a threshold temperature after laser exposure. The threshold temperature may be approximately one-half of the melting temperature of the metallic powder material, for example, approximately 700 degrees Celsius (°C) for Inconel 718.

In various implementations, the physics-based thermal model 138 may include a graph theory-based thermal model that represents the geometry of the part 112 as a mesh-free network of nodes connected by edges. The graph theory-based thermal model constructs a discrete Laplacian matrix from the network and computes eigenvalues and eigenvectors of the Laplacian matrix. The thermal history is predicted as a semi-analytical solution to the heat diffusion equation expressed as a function of the eigenvalues, eigenvectors, and processing conditions. In various implementations, the physics-based thermal model 138 may employ a super-layer approach in which a plurality of actual layers are simulated as a single simulated layer to reduce computation time. For example, in one implementation, five actual layers of 30 µm each are simulated as a single super-layer of 150 µm. Other physics-based thermal modeling approaches, such as finite element methods, finite difference methods, or analytical solutions, may also be used.

In various implementations, the physics-based thermal model 138 may be calibrated by adjusting heat transfer boundary coefficients based on a comparison of the predicted end-of-cycle temperature to the end-of-cycle temperature (T e) measured by the LWIR thermal camera 122. The heat transfer boundary coefficients may include a heat loss coefficient from the part 112 to the build plate 114, a heat loss coefficient from the part 112 to surrounding powder in the powder bed 110, and a heat loss coefficient from the part 112 to a gas flow within the build chamber 104. This calibration step enables cross-validation between the virtual process model and the physical sensor observations, which is a characteristic of the digital twin approach.

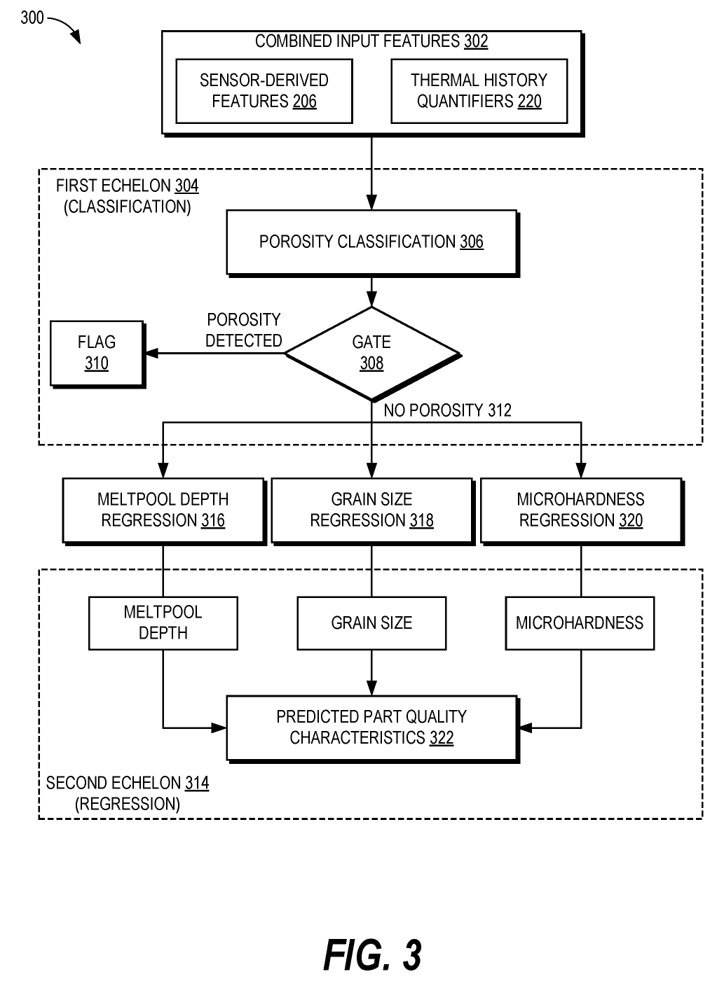

The computing device 128 further includes a hierarchical machine learning model 140 that receives the sensor-derived features from the sensor feature extractor 136 and the thermal history quantifiers from the physics-based thermal model 138, and predicts one or more part quality characteristics. The hierarchical machine learning model 140 combines both sensor-derived features and simulation-derived thermal history quantifiers as inputs, coupling multi-scale process phenomena: the sensor data captures real-time process stochasticity and surface-level phenomena, while the simulation-derived quantifiers capture sub-surface thermal gradients and cooling rates that are not directly observable by in-situ sensors. The hierarchical machine learning model 140 is described in further detail with reference to FIG. 3.

The computing device 128 further includes a quality prediction output 142 that provides the predicted part quality characteristics generated by the hierarchical machine learning model 140. The quality prediction output 142 may provide the predicted part quality characteristics on a layer-by-layer basis for each part 112 on the build plate 114. In various implementations, the quality prediction output 142 may be communicated to a display for review by an operator, stored in the storage 134 for subsequent analysis, or transmitted to another computing device over a network. The predicted part quality characteristics may include one or more of: a classification of the presence or absence of lack-of-fusion porosity, a meltpool depth, a primary dendritic arm spacing (a measure of grain size), or a microhardness.

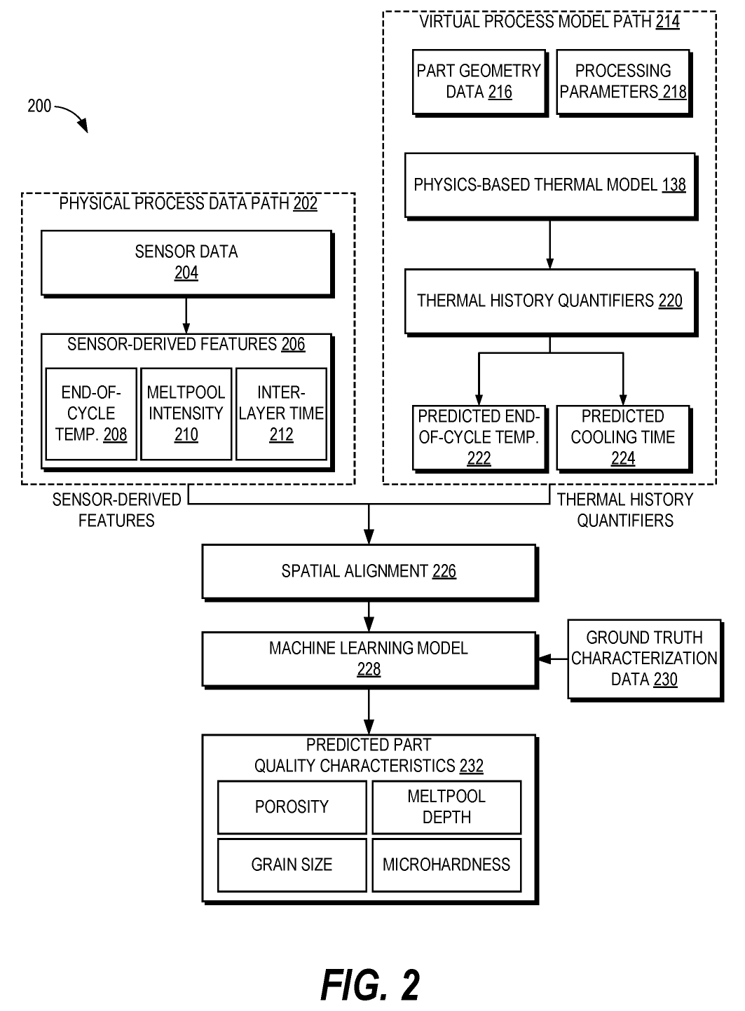

Turning to FIG. 2, shown is a schematic block diagram of a digital twin data fusion architecture 200 according to various implementations of the present disclosure. The digital twin data fusion architecture 200 illustrates how the computing device 128 (FIG. 1) combines information from two parallel data paths to predict part quality characteristics for the part 112 (FIG. 1) during fabrication. The digital twin data fusion architecture 200 includes a physical process data path 202 and a virtual process model path 214. The physical process data path 202 captures real-time observations of the LPBF process from the sensor array 120 (FIG. 1), while the virtual process model path 214 generates predictions of the thermal history of the part 112 from a computational simulation. The convergence of the physical process data path 202 and the virtual process model path 214 within a machine learning model 228 constitutes the digital twin approach, in which a virtual representation of the fabrication process augments physical sensor observations with sub-surface thermal information that is not directly observable by in-situ sensors.

The physical process data path 202 begins with sensor data 204 acquired from the sensor array 120 (FIG. 1) during fabrication of the part 112. The sensor data 204 includes data from the LWIR thermal camera 122 and the optical tomography sensor 124 (FIG. 1), acquired continuously on a layer-by-layer basis throughout the build.

The sensor feature extractor 136 (FIG. 1) processes the sensor data 204 to extract sensor-derived features 206. The sensor-derived features 206 include three process signatures that capture complementary aspects of the LPBF process at different phenomenological scales.

An end-of-cycle temperature (T e) 208 is extracted from the LWIR thermal camera 122 (FIG. 1). The end-of-cycle temperature (T e) 208 represents the average surface temperature of the part 112 at a given layer after the laser has melted the layer, a subsequent layer of powder has been deposited by the recoater 116 (FIG. 1), but the subsequent layer has not yet been melted. The end-of-cycle temperature (T e) 208 is responsive to part-level thermal phenomena, such as heat retention caused by the geometry of the part 112. For example, overhang regions and regions adjacent to enclosed cavities may exhibit elevated end-of-cycle temperatures due to impeded heat flux to the build plate 114 (FIG. 1). In various implementations, a layer-wise mean and spatial standard deviation (σT e) of the end-of-cycle temperature (T e) 208 are computed for each part 112 on the build plate 114.

A meltpool intensity (I m) 210 is extracted from the optical tomography sensor 124 (FIG. 1). The meltpool intensity (I m) 210 represents the maximum near-infrared light intensity recorded at each pixel for each layer during the laser scanning operation. The meltpool intensity (I m) 210 is responsive to meltpool-level phenomena that are influenced by the processing parameters, such as the laser power and scan velocity. In various implementations, the meltpool intensity (I m) 210 responds to changes in processing parameters to a greater magnitude than to changes in part geometry. Conversely, the end-of-cycle temperature (T e) 208 responds to changes in part geometry to a greater magnitude than to changes in processing parameters. This complementary responsiveness is a basis for combining both sensor-derived features in the digital twin approach. In various implementations, a layer-wise mean and spatial standard deviation (σI m) of the meltpool intensity (I m) 210 are computed for each part 112.

An inter-layer time (t I) 212 is derived from the time-synchronized data acquired by both the LWIR thermal camera 122 and the optical tomography sensor 124 via the synchronization link 126 (FIG. 1). The inter-layer time (t I) 212 is the duration between the peak of the laser strike at a location, as determined from a timestamp of the meltpool intensity (I m) 210, and the end-of-cycle temperature at that location, as determined from a timestamp of the end-of-cycle temperature (T e) 208. In various implementations, the inter-layer time (t I) 212 is responsive to changes in the cross-sectional area of the build. For example, as the cross-sectional area of parts on the build plate 114 decreases, such as when a cone-shaped part is completed, the inter-layer time (t I) 212 decreases because the laser traverses a smaller area before the next layer of powder is deposited.

The virtual process model path 214 begins with part geometry data 216 and processing parameters 218. The part geometry data 216 includes a digital representation of the geometry of the part 112, such as a computer-aided design (CAD) model or a stereolithography (STL) file. The processing parameters 218 include the laser power, scan velocity, hatch spacing, layer thickness, and other process settings applied during fabrication of the part 112. In various implementations, the processing parameters 218 are received from the machine controller 118 (FIG. 1).

The part geometry data 216 and the processing parameters 218 are provided as inputs to the physics-based thermal model 138 (FIG. 1). The physics-based thermal model 138 predicts the spatiotemporal temperature distribution within the part 112 and outputs thermal history quantifiers 220 for each layer of the part 112.

The thermal history quantifiers 220 include a predicted end-of-cycle temperature (T̂ e) 222. The predicted end-of-cycle temperature (T̂ e) 222 is the model-predicted counterpart to the end-of-cycle temperature (T e) 208 measured by the LWIR thermal camera 122. In various implementations, the predicted end-of-cycle temperature (T̂ e) 222 may be calibrated against the measured end-of-cycle temperature (T e) 208 by adjusting heat transfer boundary coefficients in the physics-based thermal model 138, as described with reference to FIG. 1. The agreement between the predicted end-of-cycle temperature (T̂ e) 222 and the measured end-of-cycle temperature (T e) 208 provides a cross-validation between the virtual process model path 214 and the physical process data path 202.

The thermal history quantifiers 220 further include a predicted cooling time (t̂ c) 224. The predicted cooling time (t̂ c) 224 represents the duration for the temperature of a layer to cool from its peak at the instant of laser exposure to a threshold temperature. The predicted cooling time (t̂ c) 224 captures sub-surface thermal phenomena, such as heat dissipation rates and thermal gradients within the part 112, that are not directly measurable by in-situ sensors positioned above or outside the part 112. A longer predicted cooling time (t̂ c) 224 indicates greater heat retention and has been correlated with grain coarsening, increased primary dendritic arm spacing, and deeper meltpool penetration.

The sensor-derived features 206 from the physical process data path 202 and the thermal history quantifiers 220 from the virtual process model path 214 are spatially aligned on a layer-by-layer basis at a spatial alignment step 226. The spatial alignment step 226 ensures that the sensor-derived features 206 and the thermal history quantifiers 220 correspond to the same physical layer of the part 112 before being provided as inputs to the machine learning model 228.

In various implementations, the spatial alignment step 226 includes agglomerating the thermal history quantifiers 220 from a super-layer resolution to an actual layer resolution. For example, where the physics-based thermal model 138 operates on a super-layer basis in which a plurality of actual layers are simulated as a single simulated layer, the thermal history quantifiers 220 generated for each super-layer are assigned to each of the corresponding actual layers. The sensor-derived features 206, which are extracted on an actual layer basis, are then aligned to the corresponding thermal history quantifiers 220 for each actual layer.

The spatial alignment step 226 may further include aligning ground truth characterization data to corresponding layers for purposes of training the machine learning model 228. For example, porosity measurements may be spatially aligned on a layer-by-layer basis by determining the distance of each porosity-containing layer from a reference surface of the part 112. Meltpool depth measurements, which may be obtained only at the topmost as-processed surface, may be aligned to the sensor-derived features 206 and thermal history quantifiers 220 for the top layers of the part 112. Grain size and microhardness measurements taken at discrete locations on the part 112 may be averaged at each z-height and assigned to surrounding layers.

The machine learning model 228 receives the spatially aligned sensor-derived features 206 and thermal history quantifiers 220 and predicts one or more part quality characteristics. The machine learning model 228 corresponds to the hierarchical machine learning model 140 (FIG. 1) and is described in further detail with reference to FIG. 3. In various implementations, the machine learning model 228 may include a k-nearest neighbors (kNN) model, although other machine learning algorithms, such as random forests, support vector machines, neural networks, or gradient boosting models, may be used.

The machine learning model 228 is trained using ground truth characterization data 230 obtained from post-process examination of previously fabricated parts. The ground truth characterization data 230 may include porosity measurements obtained from optical microscopy and scanning electron microscopy (SEM), meltpool depth measurements obtained from etched cross-sections examined under optical microscopy, grain size measurements in terms of primary dendritic arm spacing (λ 1) obtained from SEM, and microhardness measurements obtained from Vickers indentation testing. The ground truth characterization data 230 is spatially aligned to corresponding layers of the previously fabricated parts via the spatial alignment step 226 to establish the training relationship between the combined input features and the measured part quality characteristics.

In various implementations, the machine learning model 228 is trained using a portion of the spatially aligned data for training and a separate portion for testing. For example, a 60-40 split may be used in which 60 percent of the data is used for training and 40 percent is used for testing. A cross-validation procedure, such as 10-fold cross-validation, may be used to mitigate overfitting and ensure repeatability of the prediction results.

The machine learning model 228 outputs predicted part quality characteristics 232. The predicted part quality characteristics 232 may include one or more of: a classification of the presence or absence of lack-of-fusion porosity, a meltpool depth (d p), a primary dendritic arm spacing (λ 1, a measure of grain size), or a microhardness (Hv). The predicted part quality characteristics 232 are provided to the quality prediction output 142 (FIG. 1) for review, storage, or further analysis.

The digital twin data fusion architecture 200 provides improved prediction accuracy relative to using either the sensor-derived features 206 or the thermal history quantifiers 220 alone. The sensor-derived features 206 capture real-time, stochastic process variations, such as disruptions in gas flow or variations in powder deposition, which are not accounted for by the physics-based thermal model 138. The thermal history quantifiers 220 capture geometry-dependent, sub-surface thermal phenomena, such as cooling rates and thermal gradients, which are not directly observable by the sensor array 120. By combining both sources of information, the machine learning model 228 has access to multi-scale process data spanning meltpool-level phenomena (from the optical tomography sensor 124), part-level surface phenomena (from the LWIR thermal camera 122), and sub-surface thermal phenomena (from the physics-based thermal model 138).

Turning to FIG. 3, shown is a schematic block diagram of a hierarchical machine learning model 300 according to various implementations of the present disclosure. The hierarchical machine learning model 300 corresponds to the hierarchical machine learning model 140 (FIG. 1) and the machine learning model 228 (FIG. 2). The hierarchical machine learning model 300 receives combined input features 302 and predicts one or more part quality characteristics for the part 112 (FIG. 1) on a layer-by-layer basis. The hierarchical machine learning model 300 employs a two-echelon architecture in which a first echelon performs a classification task and a second echelon performs a regression task, as described herein.

The combined input features 302 include the sensor-derived features 206 (FIG. 2) and the thermal history quantifiers 220 (FIG. 2), spatially aligned on a layer-by-layer basis by the spatial alignment step 226 (FIG. 2). The sensor-derived features 206 may include the end-of-cycle temperature (T e) 208, the meltpool intensity (I m) 210, the inter-layer time (t_{I}) 212, and spatial standard deviations thereof, as described with reference to FIG. 2. The thermal history quantifiers 220 may include the predicted end-of-cycle temperature 222 and the predicted cooling time 224, and spatial standard deviations thereof, as described with reference to FIG. 2. Depending on the part quality characteristic being predicted, a subset of the combined input features 302 may be selected, as described in further detail below.

The hierarchical machine learning model 300 includes a first echelon 304 that performs a classification task. The first echelon 304 is a classification-type machine learning model that classifies each layer of the part 112 into one of two classes: the presence of lack-of-fusion porosity, or the absence of lack-of-fusion porosity. Lack-of-fusion porosity occurs when insufficient energy is delivered to the powder material, resulting in incomplete melting and the formation of non-circular, jagged-edged voids that may exceed 100 micrometers (µm) in diameter. In safety-critical applications, the presence of lack-of-fusion porosity is generally considered unacceptable, and parts exhibiting lack-of-fusion porosity are often rejected. Accordingly, the first echelon 304 serves as a quality gate that identifies layers or regions of the part 112 in which a fabrication defect has occurred before attempting to predict microstructure characteristics.

The first echelon 304 includes a porosity classification 306 that receives a subset of the combined input features 302 and outputs a binary classification for each layer. In various implementations, the porosity classification 306 may use four input features: the mean meltpool intensity (I m), the mean end-of-cycle temperature (T e), the mean predicted end-of-cycle temperature, and the mean predicted cooling time. Lack-of-fusion porosity may be correlated to reduced meltpool intensity (I m) and shorter predicted cooling times, because insufficient input energy results in both reduced near-infrared emission during laser scanning and rapid dissipation of heat.

The output of the porosity classification 306 is provided to a gate 308. The gate 308 directs the flow of the hierarchical machine learning model 300 based on the classification result. If the porosity classification 306 classifies a layer as having lack-of-fusion porosity, the gate 308 routes the result to a flag 310. The flag 310 indicates that porosity has been detected at the corresponding layer or region of the part 112. In various implementations, the flag 310 may trigger an alert to an operator, an entry in a quality log, or other notification that a fabrication defect has been identified. The flag 310 may further indicate that the corresponding layer or region is excluded from microstructure prediction by the second echelon, because predicting microstructure characteristics for regions with lack-of-fusion porosity may not be meaningful for purposes of part qualification.

If the porosity classification 306 classifies a layer as free of lack-of-fusion porosity, the gate 308 routes the corresponding combined input features 302 to a no porosity path 312 that proceeds to a second echelon 314.

The hierarchical machine learning model 300 further includes the second echelon 314 that performs regression tasks for layers classified as free of porosity by the first echelon 304. The second echelon 314 predicts quantitative values of one or more microstructure characteristics on a layer-by-layer basis. The second echelon 314 includes a meltpool depth regression 316, a grain size regression 318, and a microhardness regression 320.

The meltpool depth regression 316 predicts the solidified meltpool depth (d p) for the part 112. The meltpool depth represents the penetration of the laser into previous layers at the topmost as-processed surface. In various implementations, the meltpool depth regression 316 may use four input features: the mean meltpool intensity (I m), the mean end-of-cycle temperature (T e), the mean predicted end-of-cycle temperature, and the mean predicted cooling time. In various implementations, because the meltpool depth is measured only at the topmost surface of the part 112, the sensor-derived features and thermal history quantifiers for the top layers of the part 112 (e.g., the top 10 actual layers) may be used as inputs to the meltpool depth regression 316. The meltpool depth is positively correlated to both the meltpool intensity (I m) and the predicted cooling time, because deeper solidified meltpools are symptomatic of increased heat retention.

The grain size regression 318 predicts the grain size of the solidified microstructure in terms of the primary dendritic arm spacing (λ 1). In various implementations, the grain size regression 318 may use five input features: the mean meltpool intensity (I m), the mean end-of-cycle temperature (T e), the inter-layer time (t I), the mean predicted end-of-cycle temperature, and the mean predicted cooling time. The inter-layer time (t I) 212 (FIG. 2) may be included as an additional input feature for the grain size regression 318 because changes in the time between layers affect the cooling rate, which in turn influences dendritic growth and grain coarsening. A longer predicted cooling time, indicating greater heat retention and a reduced cooling rate, provides dendrites more time to grow, resulting in a coarser microstructure with larger primary dendritic arm spacing.

The microhardness regression 320 predicts the microhardness (Hv) of the solidified material. In various implementations, the microhardness regression 320 may use eight input features: the mean meltpool intensity (I m), the spatial standard deviation of the meltpool intensity (σI m), the mean end-of-cycle temperature (T e), the spatial standard deviation of the end-of-cycle temperature (σT e), the inter-layer time (t I), the mean predicted end-of-cycle temperature, the spatial standard deviation of the predicted end-of-cycle temperature, and the mean predicted cooling time. The microhardness regression 320 may use a greater number of input features than the meltpool depth regression 316 or the grain size regression 318 because variation in microhardness is governed by a more complex interplay of thermal history factors that may not be adequately captured by mean values alone. For example, in precipitation-hardening alloys such as Inconel 718, increased heat retention and reduced cooling rates may facilitate the precipitation of strengthening phases that enhance microhardness, resulting in a positive correlation between microhardness and cooling time that is counterintuitive relative to the Hall-Petch effect.

As described above, the number of input features provided to the hierarchical machine learning model 300 may vary depending on the part quality characteristic being predicted. For example, the porosity classification 306 and the meltpool depth regression 316 may each use four input features, the grain size regression 318 may use five input features, and the microhardness regression 320 may use eight input features. This variable feature selection enables each regression model to use the input features most relevant to the particular quality characteristic, while avoiding the inclusion of features that may introduce noise or reduce prediction accuracy for that characteristic.

In various implementations, a kNN machine learning model may be employed at both the first echelon 304 and the second echelon 314. A kNN model is applicable to both classification and regression tasks and can operate effectively with limited training data, which may be advantageous given the expense associated with obtaining ground truth metallurgical characterization data in LPBF. In various implementations, other machine learning algorithms, such as random forests, support vector machines, neural networks, or gradient boosting models, may be used at either or both echelons.

The outputs of the first echelon 304 (the porosity classification result from the flag 310 or the no porosity path 312) and the second echelon 314 (the meltpool depth from the meltpool depth regression 316, the grain size from the grain size regression 318, and the microhardness from the microhardness regression 320) are combined as predicted part quality characteristics 322. The predicted part quality characteristics 322 are provided to the quality prediction output 142 (FIG. 1) on a layer-by-layer basis for each part 112 on the build plate 114 (FIG. 1).

The hierarchical architecture of the hierarchical machine learning model 300 provides several advantages relative to a single-stage prediction model. The first echelon 304 enables early detection of fabrication defects during the build, providing an operator with an indication of process instability before microstructure prediction is performed. By excluding regions with lack-of-fusion porosity from microstructure prediction, the second echelon 314 operates on data that is representative of defect-free material, which may improve prediction accuracy. Additionally, the variable feature selection across the meltpool depth regression 316, the grain size regression 318, and the microhardness regression 320 allows each regression model to be tailored to the specific physical phenomena governing that quality characteristic.

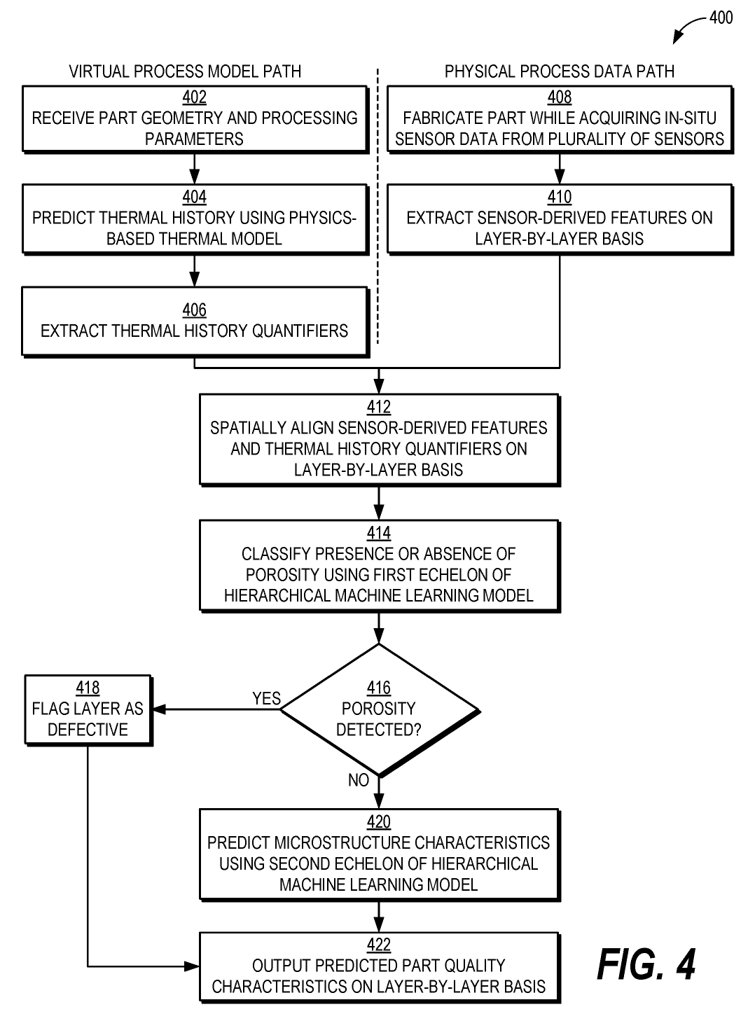

Turning to FIG. 4, shown is a flow diagram of a method 400 for in-situ prediction of part quality using a digital twin according to various implementations of the present disclosure. The method 400 may be performed by the computing device 128 (FIG. 1) using the digital twin data fusion architecture 200 (FIG. 2) and the hierarchical machine learning model 300 (FIG. 3). The method 400 includes two parallel paths that can be performed concurrently: a virtual process model path and a physical process data path. The virtual process model path generates simulation-derived thermal history quantifiers from a physics-based thermal model, and the physical process data path acquires and processes in-situ sensor data during fabrication. The two paths converge at a spatial alignment step, after which the combined data is provided to a hierarchical machine learning model for prediction of part quality characteristics.

The method 400 begins at block 402, in which the computing device 128 receives a part geometry and processing parameters for a part to be fabricated by an additive manufacturing process, such as a LPBF process. The part geometry may include a digital representation of the part, such as a CAD model or a STL file. The processing parameters may include a laser power, a scan velocity, a hatch spacing, a layer thickness, and other process settings. In various implementations, the processing parameters may be received from the machine controller 118 (FIG. 1).

From block 402, the method 400 proceeds to block 404, in which the computing device 128 predicts a thermal history of the part using a physics-based thermal model. The physics-based thermal model may be the physics-based thermal model 138 (FIG. 1). In various implementations, the physics-based thermal model predicts the spatiotemporal temperature distribution within the part as a function of the part geometry, material properties, and processing parameters. In various implementations, the physics-based thermal model may include a graph theory-based thermal model that discretizes the part geometry into a plurality of nodes connected by edges to form a network graph, constructs a Laplacian matrix from the network graph, and computes eigenvalues and eigenvectors of the Laplacian matrix, as described with reference to FIG. 1. In various implementations, the physics-based thermal model may employ a super-layer approach in which a plurality of actual layers are simulated as a single simulated layer.

From block 404, the method 400 proceeds to block 406, in which the computing device 128 extracts thermal history quantifiers from the predicted thermal history. The thermal history quantifiers may include a predicted end-of-cycle temperature and a predicted cooling time for each layer of the part, as described with reference to the thermal history quantifiers 220 (FIG. 2).

In parallel with blocks 402, 404, and 406, the method 400 includes block 408, in which the part is fabricated by the LPBF system 102 (FIG. 1) while in-situ sensor data is acquired from a plurality of sensors. The plurality of sensors may include the LWIR thermal camera 122 and the optical tomography sensor 124 of the sensor array 120 (FIG. 1). The sensor data is acquired continuously during fabrication on a layer-by-layer basis. In various implementations, the LWIR thermal camera 122 and the optical tomography sensor 124 are synchronized in time via the synchronization link 126 (FIG. 1).

From block 408, the method 400 proceeds to block 410, in which the computing device 128 extracts sensor-derived features from the in-situ sensor data on a layer-by-layer basis. The sensor-derived features may include an end-of-cycle temperature (T e) extracted from the LWIR thermal camera 122, a meltpool intensity (I m) extracted from the optical tomography sensor 124, and an inter-layer time (t I) derived from the time-synchronized data of both sensors, as described with reference to the sensor-derived features 206 (FIG. 2). In various implementations, the sensor-derived features may further include spatial standard deviations of the end-of-cycle temperature and the meltpool intensity.

From blocks 406 and 410, the method 400 proceeds to block 412, in which the computing device 128 spatially aligns the sensor-derived features and the thermal history quantifiers on a layer-by-layer basis. In various implementations, the spatial alignment includes agglomerating the thermal history quantifiers from a super-layer resolution to an actual layer resolution, such that the thermal history quantifiers generated for each super-layer are assigned to each of the corresponding actual layers. The sensor-derived features, which are extracted on an actual layer basis, are aligned to the corresponding thermal history quantifiers for each actual layer. The spatial alignment step ensures that the sensor-derived features and the thermal history quantifiers provided as inputs to the machine learning model correspond to the same physical layer of the part.

From block 412, the method 400 proceeds to block 414, in which the computing device 128 classifies the presence or absence of porosity using a first echelon of a hierarchical machine learning model. The first echelon may correspond to the first echelon 304 of the hierarchical machine learning model 300 (FIG. 3). The first echelon receives the spatially aligned sensor-derived features and thermal history quantifiers and outputs a binary classification for each layer: the presence of lack-of-fusion porosity, or the absence of lack-of-fusion porosity. In various implementations, the first echelon may use four input features, including the mean meltpool intensity, the mean end-of-cycle temperature, the mean predicted end-of-cycle temperature, and the mean predicted cooling time, as described with reference to the porosity classification 306 (FIG. 3).

From block 414, the method 400 proceeds to block 416, in which the computing device 128 determines whether porosity has been detected at the current layer. Block 416 is a decision point corresponding to the gate 308 (FIG. 3).

If, at block 416, porosity is detected (YES), the method 400 proceeds to block 418, in which the computing device 128 flags the layer as defective. In various implementations, the flag may include an alert communicated to an operator, an entry in a quality log stored in the storage 134 (FIG. 1), or other notification indicating that a fabrication defect has been identified at the corresponding layer. The flagged layer is excluded from microstructure prediction by the second echelon. From block 418, the method 400 proceeds to block 422.

If, at block 416, porosity is not detected (NO), the method 400 proceeds to block 420, in which the computing device 128 predicts one or more microstructure characteristics using a second echelon of the hierarchical machine learning model. The second echelon may correspond to the second echelon 314 of the hierarchical machine learning model 300 (FIG. 3). The second echelon receives the spatially aligned sensor-derived features and thermal history quantifiers for the layers classified as free of porosity and predicts quantitative values of at least one of a meltpool depth, a grain size (in terms of primary dendritic arm spacing), or a microhardness. In various implementations, the number of input features provided to the second echelon may vary depending on the microstructure characteristic being predicted, as described with reference to the meltpool depth regression 316, the grain size regression 318, and the microhardness regression 320 (FIG. 3).

From block 418 or block 420, the method 400 proceeds to block 422, in which the computing device 128 outputs the predicted part quality characteristics on a layer-by-layer basis. The predicted part quality characteristics may include the porosity classification result from block 414 (including any flags from block 418) and the predicted microstructure characteristics from block 420. The predicted part quality characteristics may be communicated to a display for review by an operator, stored in the storage 134 (FIG. 1) for subsequent analysis, or transmitted to another computing device over a network, as described with reference to the quality prediction output 142 (FIG. 1).

In various implementations, the method 400 is repeated for each layer of the part during fabrication. As each new layer is deposited and melted by the LPBF system 102 (FIG. 1), the sensor array 120 (FIG. 1) acquires new sensor data for that layer, and the sensor-derived features are extracted and spatially aligned to the corresponding thermal history quantifiers. The hierarchical machine learning model classifies the presence or absence of porosity and, for layers free of porosity, predicts the microstructure characteristics. In this manner, the method 400 provides a continuous, layer-by-layer quality assessment of the part throughout the fabrication process.

In various implementations, the thermal history may be predicted prior to commencement of fabrication at block 408, such that the thermal history quantifiers for all layers of the part are available when the sensor-derived features are extracted during fabrication. In other implementations, the thermal history may be predicted concurrently with fabrication, with the thermal history quantifiers computed as each layer is deposited. In various implementations, the method 400 may further include calibrating the physics-based thermal model by adjusting heat transfer boundary coefficients based on a comparison of the predicted end-of-cycle temperature to the measured end-of-cycle temperature from the in-situ sensor data, as described with reference to FIG. 1.

The features, structures, or characteristics described above can be combined in one or more implementations in any suitable manner, and the features discussed in the various implementations are interchangeable. A person skilled in the art will appreciate that the systems and methods disclosed herein can be practiced without one or more of the specific details, or other methods, components, or materials can be employed. In other instances, well-known structures, materials, or operations are not shown or described in detail to avoid obscuring aspects of the present disclosure.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described implementations of the present disclosure are merely possible examples set forth for a clear understanding of the principles of the disclosure. Many variations and modifications may be made to the above-described implementations without departing substantially from the spirit and principles of the disclosure. All such modifications and variations are intended to be included herein within the scope of this disclosure and protected by the following claims.

What is claimed is:

1. A system, comprising:
at least one computing device; and
instructions stored in the at least one computing device that, when executed by at least one processor of the at least one computing device, cause the at least one computing device to at least:
acquire in-situ sensor data from a plurality of sensors during fabrication of a part by an additive manufacturing process;
extract sensor-derived features from the in-situ sensor data on a layer-by-layer basis;
predict thermal history quantifiers for the part using a physics-based thermal model;
input the sensor-derived features and the thermal history quantifiers to a machine learning model trained on ground-truth characterization data; and
output a predicted part quality characteristic for the part based on an output of the machine learning model.

2. The system of claim 1, further comprising instructions that, when executed by the at least one processor, further cause the at least one computing device to classify, using a first echelon of the machine learning model, a presence or absence of porosity for each layer of the part, and for layers classified as absence of porosity, predict, using a second echelon of the machine learning model, at least one of a meltpool depth, a grain size, or a microhardness.

3. The system of claim 1, wherein the plurality of sensors comprises a long-wave infrared thermal camera and an optical tomography sensor.

4. The system of claim 3, wherein the sensor-derived features comprise an end-of-cycle temperature extracted from the long-wave infrared thermal camera, a meltpool intensity extracted from the optical tomography sensor, and an inter-layer time derived from time-synchronized data acquired by the long-wave infrared thermal camera and the optical tomography sensor.

5. The system of claim 1, wherein the thermal history quantifiers comprise a predicted end-of-cycle temperature and a predicted cooling time.

6. The system of claim 1, wherein the physics-based thermal model comprises a graph theory-based thermal model that discretizes a geometry of the part into a plurality of nodes connected by edges to form a network graph, constructs a Laplacian matrix from the network graph, and computes eigenvalues and eigenvectors of the Laplacian matrix.

7. The system of claim 1, wherein the sensor-derived features further comprise at least one of a spatial standard deviation of an end-of-cycle temperature, a spatial standard deviation of a meltpool intensity, or a spatial standard deviation of a predicted end-of-cycle temperature.

8. The system of claim 1, wherein the predicted part quality characteristic comprises at least one of: a classification of lack-of-fusion porosity, a meltpool depth, a primary dendritic arm spacing, or a microhardness.

9. A computer-implemented method, comprising:
acquiring, by at least one computing device, in-situ sensor data from a plurality of sensors during fabrication of a part by an additive manufacturing process;
extracting, by the at least one computing device, sensor-derived features from the in-situ sensor data on a layer-by-layer basis;
predicting, by the at least one computing device, thermal history quantifiers for the part using a physics-based thermal model;
spatially aligning, by the at least one computing device, the sensor-derived features and the thermal history quantifiers on a layer-by-layer basis;
inputting, by the at least one computing device, the spatially aligned sensor-derived features and the thermal history quantifiers to a machine learning model; and
predicting, by the at least one computing device, at least one part quality characteristic based on an output of the machine learning model.

10. The computer-implemented method of claim 9, wherein predicting the at least one part quality characteristic comprises:
classifying, using a first echelon of the machine learning model, a presence or absence of lack-of-fusion porosity for each layer of the part; and
for layers classified as absence of lack-of-fusion porosity, predicting, using a second echelon of the machine learning model, at least one of a meltpool depth, a grain size, or a microhardness.

11. The computer-implemented method of claim 9, wherein spatially aligning comprises agglomerating thermal history quantifiers from a super-layer resolution to an actual layer resolution.

12. The computer-implemented method of claim 9, wherein the sensor-derived features comprise an inter-layer time computed as a duration between a peak meltpool intensity timestamp acquired from an optical tomography sensor and an end-of-cycle temperature timestamp acquired from a long-wave infrared thermal camera.

13. The computer-implemented method of claim 9, further comprising calibrating the physics-based thermal model by adjusting heat transfer boundary coefficients based on a comparison of a model-predicted end-of-cycle temperature to a measured end-of-cycle temperature extracted from the in-situ sensor data, wherein the heat transfer boundary coefficients comprise a heat loss coefficient from the part to a build plate, a heat loss coefficient from the part to surrounding powder, and a heat loss coefficient from the part to a gas flow.

14. The computer-implemented method of claim 9, wherein a number of input features provided to the machine learning model varies depending on the part quality characteristic being predicted.

15. The computer-implemented method of claim 9, wherein the machine learning model comprises a k-nearest neighbors model.

16. The computer-implemented method of claim 9, wherein the additive manufacturing process comprises a laser powder bed fusion process.

17. A non-transitory computer-readable medium storing instructions that, when executed by at least one processor, cause the at least one processor to at least:
receive in-situ sensor data acquired from a plurality of sensors during fabrication of a part by an additive manufacturing process;
extract sensor-derived features from the in-situ sensor data;
predict thermal history quantifiers for the part using a physics-based thermal model;
combine the sensor-derived features and the thermal history quantifiers as inputs to a hierarchical machine learning model, the hierarchical machine learning model comprising a first echelon that classifies a presence or absence of a fabrication defect and a second echelon that predicts a microstructure characteristic for portions of the part classified as absence of the fabrication defect; and
output the predicted microstructure characteristic.

18. The non-transitory computer-readable medium of claim 17, wherein the fabrication defect comprises lack-of-fusion porosity, and the microstructure characteristic comprises at least one of a meltpool depth, a primary dendritic arm spacing, or a microhardness.

19. The non-transitory computer-readable medium of claim 17, wherein the sensor-derived features and the thermal history quantifiers are spatially aligned on a layer-by-layer basis prior to input to the hierarchical machine learning model.

20. The non-transitory computer-readable medium of claim 17, wherein the physics-based thermal model predicts the thermal history quantifiers using a mesh-free computational approach that represents a geometry of the part as a network graph of nodes connected by edges.
